(19) United States
(12) Patent Application Publication
(10) Pub. No.: US 2009/0152427 A1
(43) Pub. Date: Jun. 18, 2009

(54) Mouse Pad

(76) Inventor: Chun-Fu Kuo, Shengang Hsiang (TW)

Correspondence Address: CHARLES E. BAXLEY, ESQUIRE, 90 JOHN STREET, SUITE 309, NEW YORK, NY, 10038, US

(21) Appl. No.: 12/317,204

(22) Filed: Dec. 19, 2008

Related U.S. Application Data
(63) Continuation-in-part of application No. 11/888,459, filed on Jul. 31, 2007, now abandoned.

(51) Int. Cl. B68G 5/00

(52) U.S. Cl. 248/346.01

(57) ABSTRACT

A mouse pad has a base and a release sheet. The base has a substrate, an adsorbent layer, a non-slip layer and at least one perforation line. The substrate has a top face and a bottom face. The adsorbent layer is formed on the top face of the substrate. The non-slip layer is formed on the bottom face of the substrate. The at least one perforation line is formed through the base to define a central segment and a peripheral segment. The release sheet is detachably mounted with the non-slip layer of the base to aid printing. Therefore, a surface provided by the mouse pad is uniform and the peripheral segment can be removed to allow the entire central segment to be covered by printing.

The present invention is a continuation-in-part of application Ser. No. 11/888,459, filed on Jul. 31, 2007.

### BACKGROUND OF THE INVENTION

1. Field of the Invention

The present invention relates to a mouse pad, and more particularly to a mouse pad that is thin enough and provides a uniform surface for printing.

2. Description of the Prior Arts

A conventional mouse pad is usually disposed on a surface to aid control of a computer mouse, is made by mounting multi-layers to each other and has an upper layer and a graphic. The graphic may be decorative patterns, words, logos or the like and is printed on the upper layer before the upper layer is mounted on the mouse pad, so increasing manufacturing costs. Furthermore, the graphic is designed and made by the manufacturer so cannot be changed or amended by the user so limiting the use and attractiveness of the conventional mouse pad.

With reference to FIGS. 10 and 11, a conventional thin mouse pad (80) can be printed with the graphic by a printer and has a substrate (81), a release sheet (82) and an adsorbent layer (83). The substrate (81) has a top face, a bottom face and an adhesive layer (811). The adhesive layer (811) is formed on the bottom face of the substrate (81) and has a corner and a cutout (812). The cutout (812) of the adhesive layer (811) may be formed in the corner of the adhesive layer (811). The release sheet (82) corresponds to and is bonded to the adhesive layer (811) and has a tab (821). The tab (821) corresponds to the cutout (812) and is not bonded to the adhesive layer (811). Therefore, the release sheet (82) can be separated from the substrate (81) by pulling the release sheet (82) using the tab (821). The adsorbent layer (83) is formed on the top face of the substrate (81) and has an inner surface, an outer surface and four edges. The inner surface of the adsorbent layer (83) is mounted on the top face of the substrate (81).

Although, the graphic can be printed on the outer surface of the adsorbent layer (83) of the thin mouse pad (80) by the printer. However, the cutout (812) of the adhesive layer (811) allows the substrate (81) and the release sheet (82) to move and cause image distortion during printing. Also, the edges of the adsorbent layer (83) may overlap the substrate (81) to cause image distortion, or the edges may be outside a printable area of the printer. In addition, when the graphic has been printed on the adsorbent layer (83), a surface hardening process needs to be used to harden the thin mouse pad (80).

Furthermore, the graphic printed on the adsorbent layer (83) of the thin mouse pad (80) may be worn down by operation of the computer mouse so the life span of the conventional thin mouse pad (80) is shortened by attrition of the adsorbent layer (83).

In addition, the conventional mouse pad or the thin mouse pad (80) may move with the computer mouse and so negatively influencing operation of the computer mouse.

To overcome the shortcomings, the present invention provides a mouse pad to mitigate or obviate the aforementioned problems.

### SUMMARY OF THE INVENTION

The main objective of the present invention is to provide a mouse pad that that is thin enough and provides a uniform surface for printing.

The mouse pad in accordance with the present invention has a base and a release sheet. The base has a substrate, an adsorbent layer, a non-slip layer and at least one perforation line. The substrate has a top face and a bottom face. The adsorbent layer is formed on the top face of the substrate. The non-slip layer is formed on the bottom face of the substrate. The at least one perforation line is formed through the adsorbent layer, the substrate and the non-slip layer to form the base as a central segment and a peripheral segment. The release sheet is detachably mounted with the non-slip layer of the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a mouse pad in accordance with the present invention;

FIG. 2 is an exploded perspective view of the mouse pad in FIG. 1;

FIG. 3 is an enlarged cross-section side view of the mouse pad in FIG. 1;

FIG. 4 is a perspective view of another embodiment of a mouse pad in accordance with the present invention;

FIGS. 5 to 8 are a series of operational perspective views of the mouse pad in FIG. 1 respectively showing printing, removing a peripheral segment, removing backing and using with a mouse;

FIG. 9 is another operational perspective view of the mouse pad in FIG. 8, shown mounted in a picture frame;

FIG. 10 is a perspective view of a mouse pad in accordance with the prior art; and

FIG. 11 is an enlarged cross-section side view of the mouse pad in FIG. 10.

### DETAILED DESCRIPTION OF THE PREFERRED EMBODIMENTS

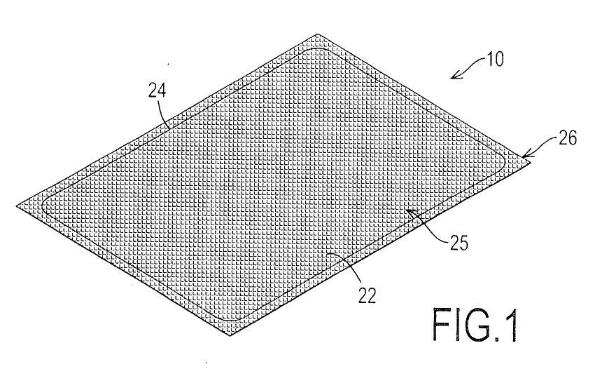

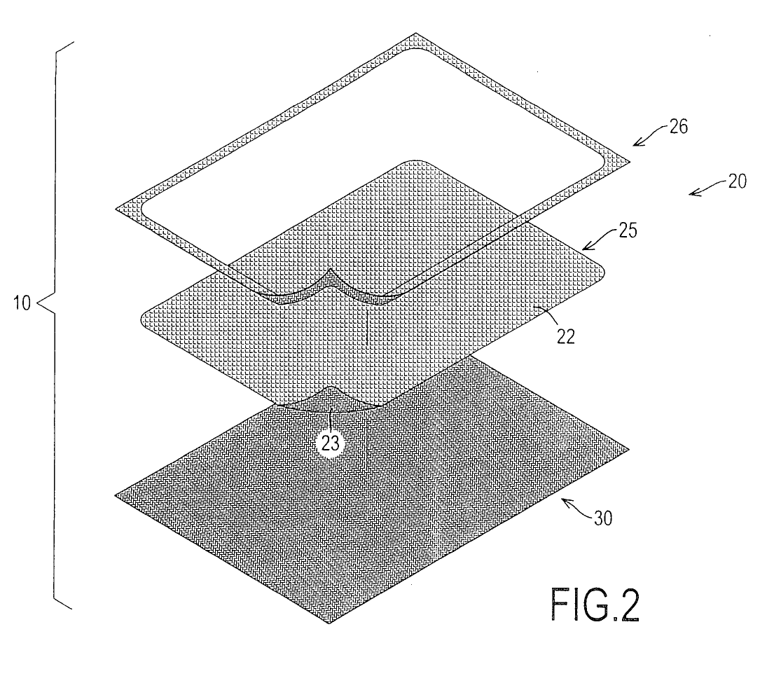

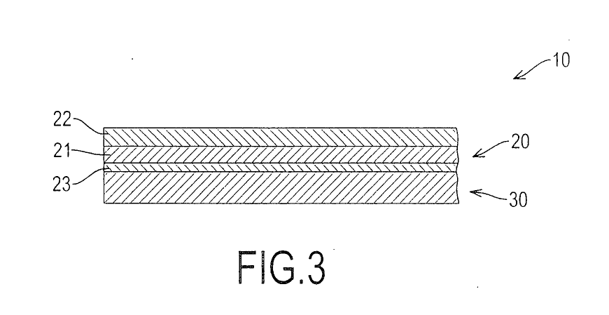

With reference to FIGS. 1 to 3, a mouse pad (10) in accordance with the present invention may less than 0.52 mm thick and comprises a base (20) and a release sheet (30).

The base (20) has a substrate (21), a adsorbent layer (22), a non-slip layer (23), at least one perforation line (24), at least one central segment (25) and a peripheral segment (26).

The substrate (21) may be rectangular, may be rubber, plastic, polyurethane, polyvinyl chloride, polyvinyl acetate, fiber or other synthetic material and has a top face, a bottom face and is between 0.1 and 0.16 millimeters thick. The adsorbent layer (22) may be about 0.08 to 0.12 millimeters thick, is made by a high-hardness fine particle-adsorptive resin mixture such as polyvinyl alcohol (P.V.A.) derivatives, polyvinyl alcohol (P.V.A.)-aluminum oxide (Al₂O₃), polyvinyl alcohol (P.V.A.)-silicon dioxide (SiO₂) or polyvinyl alcohol (P.V.A.)-aluminum hydroxide (Al(OH)₃) to provide a high hardness structure, allows adhesive bonding to adsorb the ink uniformly of a printer, is waterproof and wear-resistant, is formed on the substrate (21) and has an outer surface.

The non-slip layer (23) may be about 0.05 to 0.1 millimeters thick, may be a synthetic material, a cross-linked polyurethane (CPU) or a rubber, is formed on the bottom face of the substrate (21) and has a lower face.

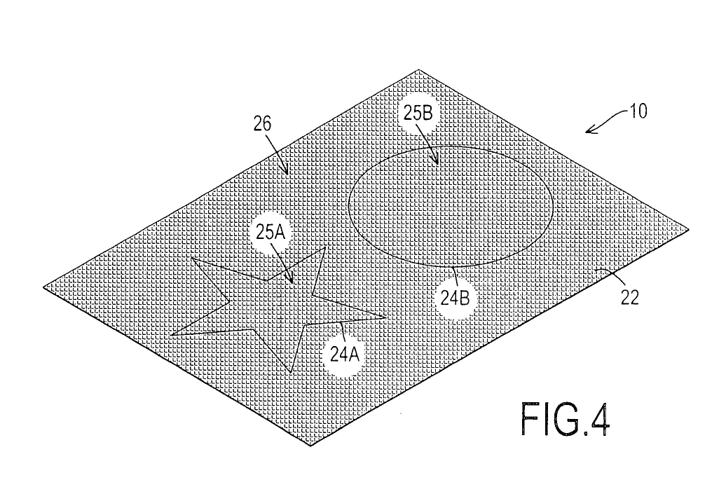

With further reference to FIG. 4, the at least one central segment (25) may be circular, polygonal or the like. In one embodiment, two central segments (25) are implemented as a circle and a star.

The at least one perforation line (24, 24A, 24B) is formed through the base (20) to define the central segment (25, 25A, 25B) and the peripheral segment (26). Two perforation lines (24A, 24B) are formed through the base (20) and one of the perforation lines (24A, 24B) is star-shaped and the other perforation line (24B) is circular.

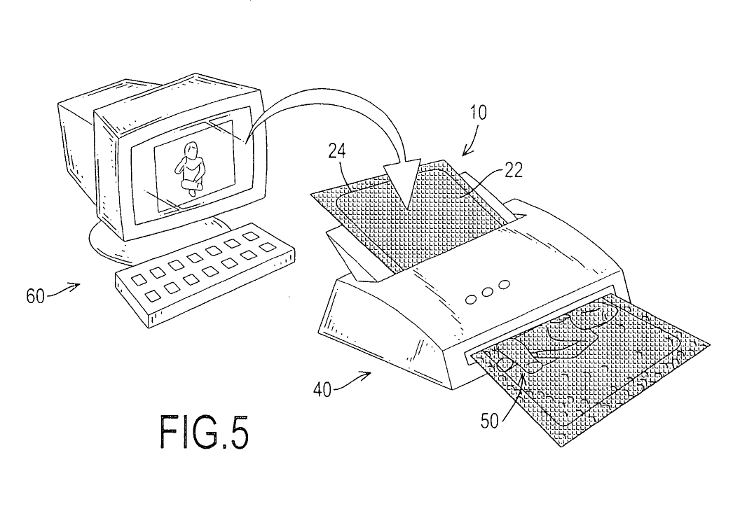

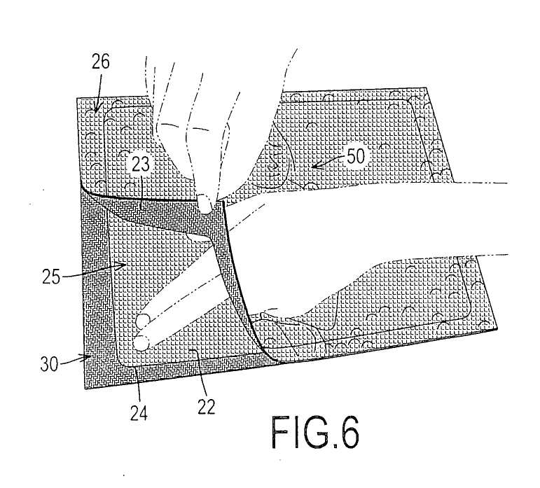

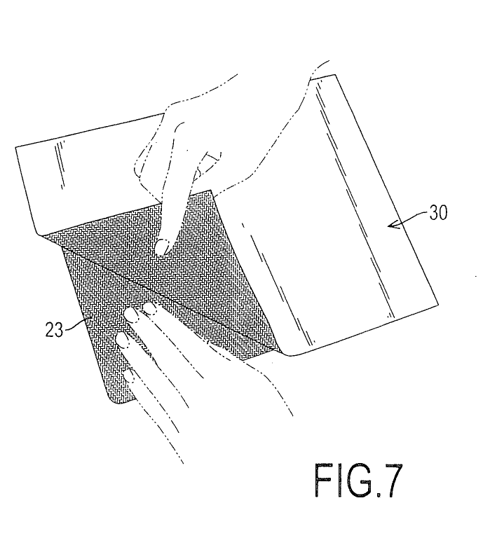

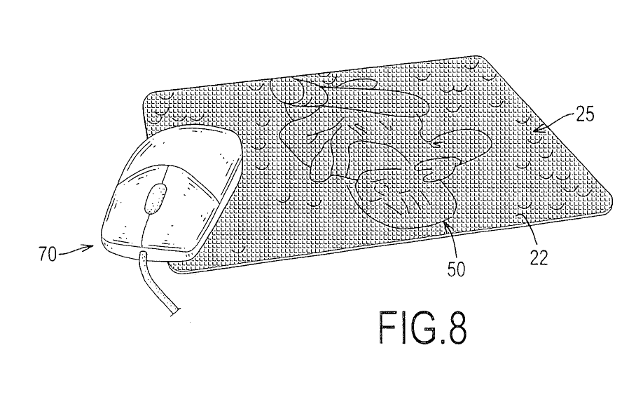

The release sheet (30) may be about 0.15 to 0.2 millimeters thick, is detachably mounted on the lower face of the non-slip layer (23) and covers the non-slip layer (23) to allow the mouse pad (10) to be printed normally. With further reference to FIGS. 5 to 8, a graphic (50), including but not limited to patterns, pictures, words or logos is designed on a computer (60) and printed on the mouse pad (10) by a standard printer (40). After printing the graphic (50), the central segment (25) of the base (20) is pressed and torn to remove the peripheral segment (26) from the base (20) along the at least one perforation line (24) and the release sheet (30) is removed from the non-slip layer (23) of the base (20). Then, the non-slip layer (23) of the base (20) is disposed stably on a surface for use with a computer mouse (70).

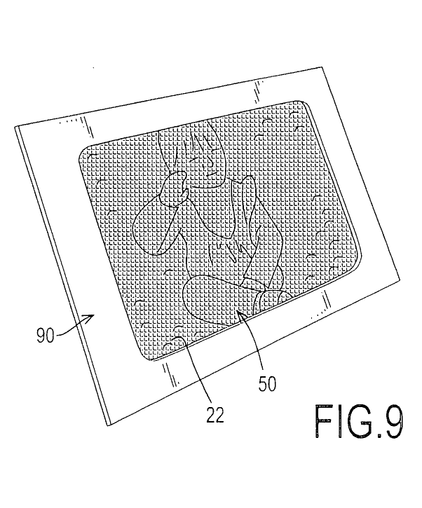

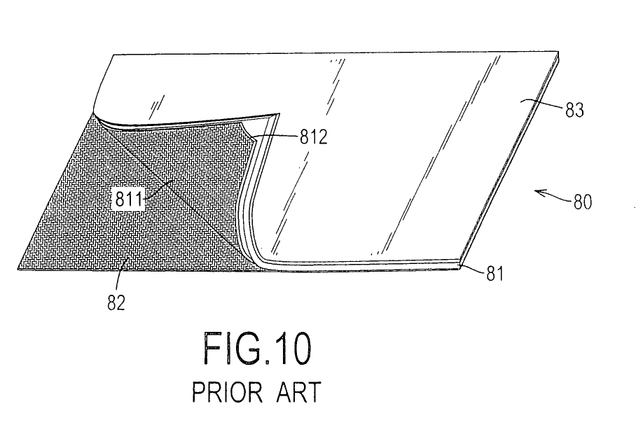

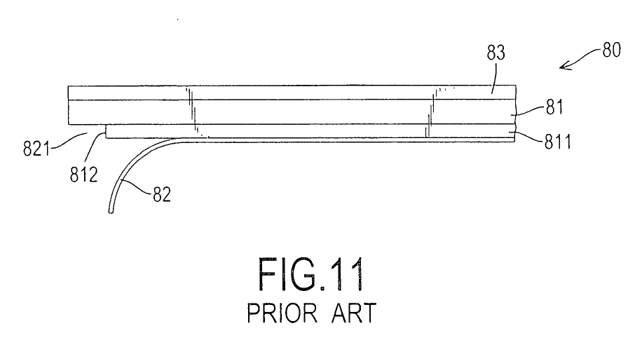

With further reference to FIG. 9, the mouse pad (10) may be put in a picture frame (90) as a gift or memory.

When printing the mouse pad (10) the release sheet (30) is evenly mounted on the base (20) so providing a uniform surface for printing. Also, the graphic (50) is printed on the central segment (25, 25A, 25B) and may overlap onto the peripheral segment (26), which is removed so the central segment of the mouse pad (10) can be covered by standard printers (40).

Furthermore, the adsorbent layer (22) of the base (20) in the present invention is polyvinyl alcohol (P.V.A.)-aluminum oxide (Al₂O₃) or polyvinyl alcohol (P.V.A.)-silicon dioxide (SiO₂), so has high hardness structure, improved adhesive, waterproof and wear-resistant properties. Therefore, the graphic (50) printed on the adsorbent layer (22) of the mouse pad (10) will not wear down by the operation of the computer mouse (70) so lengthens the life of the mouse pad (10).

In addition, the non-slip layer (23) of the base (20) can be securely disposed on a surface to avoid the mouse pad (10) moving with the computer mouse (70) without negatively effecting printing of the mouse pad (10). Then, the mouse pad (10) will not move with the computer mouse (70) and this can improve the operation of using the computer mouse (70).

The mouse pad (10) can be put in a picture frame (90) for additional function.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A mouse pad having:
a base having
a substrate and having
a top face; and
a bottom face;
an adsorbent layer being made by a high-hardness fine particle-adsorptive resin mixture and being formed on the substrate and having an outer surface;
a non-slip layer being formed on the bottom face of the substrate and having
a lower face; and
at least one perforation line being formed through the base to define a central segment and a peripheral segment of the base; and
a release sheet being detachably mounted on the lower face of the non-slip layer.

2. The mouse pad as claimed in claim 1, wherein the adsorbent layer is selected from the group consisting of polyvinyl alcohol (P.V.A.) derivatives-aluminum oxide (Al₂O₃), polyvinyl alcohol (P.V.A.) derivatives-silicon dioxide (SiO₂) and polyvinyl alcohol (P.V.A.) derivatives-aluminum hydroxide (Al(OH)₃).

3. The mouse pad as claimed in claim 2, wherein the non-slip layer is synthetic material.

4. The mouse pad as claimed in claim 2, wherein the non-slip layer is cross-linked polyurethane (CPU).

5. The mouse pad as claimed in claim 2, wherein the non-slip layer is rubber.

6. The mouse pad as claimed in claim 2, wherein the mouse pad is thinner than 0.52 millimeters.

7. The mouse pad as claimed in claim 6, wherein the substrate is between 0.1 and 0.16 mm thick.

8. The mouse pad as claimed in claim 7, wherein the adsorbent layer is between 0.08 and 0.12 mm thick.

9. The mouse pad as claimed in claim 8, wherein the non-slip layer is between 0.05 and 0.1 mm thick.

10. The mouse pad as claimed in claim 9, wherein the release sheet is between 0.15 and 0.2 mm thick.

11. The mouse pad as claimed in claim 10, wherein two perforation lines are formed through the base.

12. The mouse pad as claimed in claim 11, wherein one of the perforation lines is star-shaped and the other perforation line is circular.

13. The mouse pad as claimed in claim 12, wherein the substrate is rubber.

14. The mouse pad as claimed in claim 12, wherein the substrate is plastic.

15. The mouse pad as claimed in claim 12, wherein the substrate is polyurethane.

16. The mouse pad as claimed in claim 12, wherein the substrate is polyvinyl chloride.

17. The mouse pad as claimed in claim 12, wherein the substrate is polyvinyl acetate.

18. The mouse pad as claimed in claim 12, wherein the substrate is fiber.

19. The mouse pad as claimed in claim 1, wherein the non-slip layer is synthetic material.

20. The mouse pad as claimed in claim 1, wherein the non-slip layer is cross-linked polyurethane (CPU).

21. The mouse pad as claimed in claim 1, wherein the non-slip layer is rubber.

22. The mouse pad as claimed in claim 1, wherein
the mouse pad is thinner than 0.52 mm;
the substrate is between 0.1 and 0.16 mm thick;
the adsorbent layer is between 0.08 and 0.12 mm thick;
the non-slip is between 0.05 and 0.1 mm thick; and
the release sheet is between 0.15 and 0.2 mm thick.

23. The mouse pad as claimed in claim 1, wherein two perforation lines are formed through the base.

24. The mouse pad as claimed in claim 1, wherein the substrate is rubber.

25. The mouse pad as claimed in claim 1, wherein the substrate is plastic.

26. The mouse pad as claimed in claim 1, wherein the substrate is polyurethane.

27. The mouse pad as claimed in claim 1, wherein the substrate is polyvinyl chloride.

28. The mouse pad as claimed in claim 1, wherein the substrate is polyvinyl acetate.

29. The mouse pad as claimed in claim 1, wherein the substrate is fiber.
